(19) United States
(12) Patent Application Publication
(10) Pub. No.: US 2025/0046818 A1
(43) Pub. Date: Feb. 6, 2025

(54) ANODE COMPOSITION WITH CROSS-LINKABLE BINDER

(71) Applicant: COATEX, Genay (FR)

(72) Inventors: Catherine CORFIAS ZUCCALLI, Villeurbanne (FR); Laurie PARRENIN, Villeneuve (FR); Jean Marc SUAU, Lucenay (FR)

(73) Assignee: COATEX, Genay (FR)

(21) Appl. No.: 18/716,368

(22) PCT Filed: Dec. 19, 2022
(86) PCT No.: PCT/FR2022/000138

§ 371 Date: Jun. 4, 2024

(30) Foreign Application Priority Data
Dec. 20, 2021 (FR) 2113996

(51) Int. Cl. H01M 4/62; H01M 4/583

(52) U.S. Cl. CPC H01M 4/622; H01M 4/583

(57) ABSTRACT

An aqueous anode composition may include carbon particles or metal particles and a crosslinkable composition. The crosslinkable composition may include a polycarboxylic polymer combined with an alcohol or an amine. The crosslinkable composition may also include (i) at least one material E chosen among metal fibers, metal particles, carbon graphite fibers, carbon graphite particles and combinations thereof and (ii) at least one cross-linkable aqueous composition R including: (a) at least one polymer A prepared in water by a polymerization reaction of at least one monomer M chosen among acrylic acid, methacrylic acid, an acrylic acid salt, a methacrylic acid salt and combinations thereof, in the presence of at least one initiator compound, and (b) at least one compound B chosen among polyols, polyamines, amino alcohols, (polyamino)alcohols, amino(polyalcohols), oses, osides, and combinations thereof.

The invention relates to an aqueous anode composition comprising carbon particles or metal particles and a crosslinkable composition. This crosslinkable composition comprises a polycarboxylic polymer combined with an alcohol or an amine. The invention also relates to a method for producing an anode using said aqueous composition.

There are known anode compositions that generally comprise carbon or a metal in the form of particles associated with a binder composition. The most common binder compositions comprise a styrene-butadiene polymer. After crosslinking, the composition makes it possible to fix the particles on a metal substrate. The binding property is therefore decisive when producing an anode using these anode compositions. In addition, mechanical strength or electrochemical resistance is particularly sought.

These anode compositions frequently comprise silicon in order to increase the capacity of the prepared anodes. During the charging-discharging cycles of the batteries containing these anodes, it is usual to observe a strain that can lead to irreversible alteration of the anode. Strain tolerance is therefore also a desirable property.

The reactions involved in crosslinking the composition must also be effectively controlled. Parasitic reactions or inhibition of the reagents used must be avoided. The formation of degradation by-products or of coloured by-products, particularly as a result of excessive exposure to high temperatures, must be reduced or avoided. These cross-linkable compositions should be highly reactive. They should allow for high reaction kinetics.

The time required to manufacture these anodes is also an important factor. It is therefore important to improve the efficacy of the various reactions involved, particularly when crosslinking the anode composition.

It should also be possible to reduce the number of ingredients used when preparing anode compositions.

Known cross-linkable compositions are used in many fields. However, some compounds should be avoided or removed from these cross-linkable compositions, in particular for efficacy and safety reasons but also for economic or environmental reasons. It can also be advantageous to be able to dispense with phosphorus compounds when preparing reagents for a cross-linkable composition or when preparing a cross-linkable composition or when applying it prior to crosslinking. It should therefore be possible to prepare esters or amides for cross-linkable compositions in the absence of any compounds that could be considered harmful from an environmental standpoint or in the absence of any compounds that are restricted for use by regulatory provisions. In particular, preparing these compounds in the absence of any compound comprising phosphorus could be preferred, especially the absence of any phosphorus in oxidation state I, III or V.

The reactions involved in crosslinking the composition present on a material must also be effectively controlled. Parasitic reactions or inhibition of the reagents used must be avoided.

It is also important to have access to improved means, in particular to cross-linkable aqueous compositions or crosslinking agents, which are necessary for manufacturing anodes.

The time required to manufacture these composites is also an important factor. It is therefore important to improve the efficacy of the various reactions involved, particularly during crosslinking.

Document JP 2021015778 describes an electrode binder that comprises a polyacrylic acid and polyol or amino alcohol copolymer with a molecular mass of 1.5 million g/mol.

Document CN 112993252 describes a cross-linkable anode binder composition comprising a polyacrylic acid polymer with a molecular mass of 200,000 g/mol, a carboxylic elastomer and a cross-linking polyol. Document EP 1300426 describes the preparation of (meth)acrylic acid copolymers and polyethoxylated isoprenol copolymers in the presence of bisulphite and persulphate.

The anode compositions in the prior art are not always satisfactory. There is thus a need for anode compositions that provide solutions to all or part of the problems of the anode compositions in the prior art.

Thus, the invention provides an aqueous anode composition T comprising:
at least one cross-linkable aqueous composition R comprising:
   a) at least one polymer A prepared in water by a polymerisation reaction of at least one monomer M chosen among acrylic acid, methacrylic acid, an acrylic acid salt, a methacrylic acid salt and combinations thereof, in the presence of at least one initiator compound,
   b) at least one compound B chosen among polyols, polyamines, amino alcohols, (polyamino)alcohols, amino(polyalcohols), oses, osides and combinations thereof,
at least one material E chosen among metal fibres, metal particles, carbon graphite fibres, carbon graphite particles and combinations thereof

Essentially for the invention, polymer A is prepared using monomer M. Preferably according to the invention, monomer M is chosen among acrylic acid, an acrylic acid salt and combinations thereof.

According to the invention, monomer M can be combined with at least one other monomer, preferably another monomer chosen among vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. When combined with another monomer, monomer M can be chosen among acrylic acid, an acid salt and combinations thereof, in combination with at least one other monomer chosen among vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulphonic acid (AMPS), maleic acid, maleic anhydride, itaconic acid and combinations thereof. In combination with another monomer, the amount by weight of the other monomer is less than the amount by weight of monomer M. Preferably according to the invention, monomer M is acrylic acid alone.

Preferably, the polymerisation reaction is carried out at a temperature above 30° C. and below 130° C., preferably below 100° C. or below 90° C. or below 80° C. or below 75° C. Preferably during the polymerisation reaction to prepare polymer A, the initiator compound is chosen among a peroxide (for example hydrogen peroxide), a hydroperoxide (for example tert-butyl hydroperoxide), a persulphate (for example sodium persulphate, ammonium persulphate, potassium persulphate), combinations thereof and their associations with a metal salt, preferably a metal salt chosen among an iron salt (for example Fe II or Fe III), a copper salt (for example Cu I or Cu II) and combinations thereof. Preferably, polymer A has a weight-average molecular mass Mw (measured by SEC) less than 1 million g/mol or less than 800,000 g/mol, preferably less than 400,000 g/mol or less than 200,000 g/mol, more preferentially less than 50,000 g/mol or less than 20,000 g/mol, more preferably less than 15,000 g/mol or less than 10,000 g/mol, even more preferentially less than 7,000 g/mol or less than 6,000 g/mol. Polymer A generally has a weight-average molecular mass Mw (measured by SEC) greater than 1,000 g/mol or greater than 1,200 g/mol.

Preferably, polymer A has a polymolecularity index PI (measured by SEC) of less than 4 or ranging from 1.2 to 4 or from 1.5 to 4; from 1.2 to 3 or from 1.5 to 3; from 1.2 to 2.5 or even from 1.5 to 2.5.

According to the invention, the molecular weight or mass of polymer A is determined by Size Exclusion Chromatography (SEC). A test portion of the polymer solution corresponding to 90 mg of dry solids is placed into a 10 mL flask. Mobile phase is added, together with 0.04% of dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, of a Waters 717+ sample changer, of an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the zone corresponding to molecular weights of more than 250 g/mol.

According to the invention, polymer A can be non-neutralised or it can be partially neutralised or completely neutralised. Preferably, polymer A is non-neutralised. According to the invention, the carboxyl groups of polymer A can be partially neutralised at a rate of 70 to 97 mol %, preferably at a rate of 90 to 95 mol %. Polymer A can be partially or completely neutralised by means of at least one monovalent ion or of at least one divalent ion. According to the invention, polymer A can be partially or completely neutralised by means of a combination of at least one monovalent ion and of at least one divalent ion. According to the invention, polymer A can then be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

According to the invention, neutralisation can be carried out by means of a primary amine, of a secondary amine or of a monovalent ion chosen among K⁺, Na⁺, Li⁺, NH₄⁺ and combinations thereof. The preferred ion is NH₄⁺. According to the invention, neutralisation can also be carried out by means of a divalent ion chosen among Ca²⁺, Mg²⁺, Zn²⁺ and combinations thereof. The preferred divalent ion is chosen among Ca²⁺, Zn²⁺ and combinations thereof.

According to the invention, polymer A can be neutralised by means of at least one compound chosen among NaOH, KOH, ammonium derivatives, ammonia, primary amine, secondary amine, CaO, Ca(OH)₂, MgO, Mg(OH)₂, ZnO, Zn(OH)₂ and combinations thereof. Neutralising polymer A with ammonia is particularly advantageous when using composition T or composition R at a pH of less than 7, preferably at a pH of less than 5. According to the invention, polymer A can be completely or partially neutralised by means of an amine base, for example a base chosen among ethylenediamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, triethanolamine, aminomethyl propanol or 2-amino-2-methyl-propanol (AMP) and combinations thereof. Advantageously according to the invention, the amine base can also be present in composition R as an amine compound B.

Preferably according to the invention, polymer A can be prepared in the presence of at least one polymerisation agent C chosen among compounds C1 to C6 and combinations thereof.

Preferably according to the invention, compound C is a sulphur compound C1 comprising sulphur in oxidation state IV, preferably a sulphur compound C1 chosen among lithium hydrogen sulphite, sodium hydrogen sulphite, potassium hydrogen sulphite, ammonium hydrogen sulphite, calcium di(hydrogen sulphite), magnesium di(hydrogen sulphite) and combinations thereof. Preferentially according to the invention, compound C1 is a mono-hydrogen sulphite. Generally according to the invention, the molar amount of sulphur compound C1, preferably the molar amount of sulphur IV, is comprised between 1% and 15%, preferably between 1.5% and 12%, relative to the total molar amount of monomers used; preferably, the molar amount of sulphur compound C1, preferably the molar amount of sulphur IV, is comprised between 1% and 15%, preferably between 1.5% and 12%, relative to the total molar amount of unsaturated groups of the monomers used.

According to the invention, compound C can be a phosphorus compound C2 comprising phosphorus in oxidation state I, preferably a phosphorus compound C2 chosen among hypophosphorous acid, sodium hypophosphite, potassium hypophosphite, lithium hypophosphite, ammonium hypophosphite, calcium hypophosphite, magnesium hypophosphite and combinations thereof. Advantageously according to the invention, when preparing polymer A in the presence of a polymerisation agent C2, phosphinocarboxylic polymers are obtained; the polymer A obtained then comprises phosphinate groups and phosphonate groups. In particular, the molar amount of phosphorus compound C2, preferably the molar amount of phosphorus I, is comprised between 1% and 15%, relative to the total molar amount of monomers used; preferably the molar amount of phosphorus compound C2, preferably the molar amount of phosphorus I, is comprised between 1.5% and 12%, relative to the total molar amount of unsaturated groups of the monomers used.

According to the invention, compound C can be a phosphorus compound C3 comprising phosphorus in oxidation state III, preferably a phosphorus compound C3 chosen among phosphorous acid, a phosphorous acid salt and combinations thereof. In particular, the molar amount of phosphorus compound C3, preferably the molar amount of phosphorus III, is comprised between 1% and 15%, relative to the total molar amount of monomers used, preferably the molar amount of phosphorus compound C3, preferably the molar amount of phosphorus III, is comprised between 1.5% and 12%, relative to the total molar amount of unsaturated groups of the monomers used.

Preferably according to the invention, compound C can be a secondary alcohol C4, preferably isopropyl alcohol.

Also preferably according to the invention, compound C can be a sulphur compound C5, preferably chosen among primary thiols, mercaptans and combinations thereof, for example tert-dodecyl mercaptan, tert-nonyl mercaptan, thiolactic acid, mercaptopropionic acid, mercaptoethanol, thioglycolic acid, 1,8-dimercapto-3,6-dioxaoctane (DMDO—CAS No. 14970-87-7).

Also preferably according to the invention, compound C is a RAFT polymerisation agent C6, preferably dipropyl trithiocarbonate (DPTTC—CAS No. 6332-91-8) or salts thereof, for example its disodium salt (sodium dipropionate trithiocarbonate, CAS No. 86470-33-2). In particular, the molar amount of compound C6, preferably the molar amount of DPTTC, is comprised between 1.5% and 12%, relative to the total molar amount of monomers used, preferably the molar amount of compound C6, preferably the molar amount of DPTTC, is comprised between 1.5% and 12%, relative to the total molar amount of unsaturated groups of the monomers used.

Also preferably according to the invention, polymer A is chosen among an α-ω-disulphonated polymer A1, an α-monosulphonated polymer A2, a polymer A3 comprising phosphinate groups, a polymer A4 comprising phosphonate groups, a polymer A5 comprising phosphinate groups and phosphonate groups and combinations thereof.

According to the invention, composition T can also comprise, preferably within composition R, a compound D chosen among sulpho-carboxy-aromatic acids and sulpho-carboxy-alkyl acids, preferably 3-sulphopropionic acid, 3-sulpho-2-methyl-propionic acid, sulpho-succinic acid, their salts and combinations thereof. The preferred salts of compound D are chosen among sodium salt, potassium salt, lithium salt, calcium salt, magnesium salt and ammonium salt. The sodium salt and ammonium salt of compound D are particularly preferred. Also preferably, composition T or composition R comprises a molar amount of compound D, measured according to the method in the examples, greater than 2% relative to the molar amount of sulphur IV in compound C1. Preferably according to the invention, composition T or composition R comprises a molar amount of compound D, measured according to the method in the examples, greater than 5%, preferably greater than 10% or greater than 15%, more preferentially greater than 20% or greater than 25%, relative to the molar amount of sulphur IV. Also preferably according to the invention, the molar amount of compound D, measured according to the method in the examples, is less than 60%, preferably less than 50% or less than 40%, relative to the molar amount of sulphur IV.

According to the invention, compound D and the amount of compound D (mol % relative to the molar amount of sulphur IV of the compound T used) are determined by sulphate ion assay and by ¹H NMR and ¹³C NMR analysis of the sulphonated groups of polymer A and of compound D.

According to the invention, the molar amount of compound D present in composition T or in composition R relative to the molar amount of sulphur IV is therefore generally comprised within the ranges of 2% to 60% or of 2% to 50% or of 2% to 40%, preferably of 5% to 60% or of 5% to 50% or of 5% to 40%. Also preferably, the molar amount of compound D present in composition T or in composition R relative to the molar amount of sulphur IV is therefore generally comprised within the ranges of 10% to 60% or of 10% to 50% or of 10% to 40%. Also preferably, the molar amount of compound D present in composition T or in composition R relative to the molar amount of sulphur IV is comprised within the ranges of 15% to 60% or of 15% to 50% or of 15% to 40% or even of 25% to 60% or of 25% to 50% or of 25% to 40% or even of 20% to 60% or of 20% to 50% or of 20% to 40%.

According to the invention, composition T can also comprise, for example within composition R, a compound F chosen among 2-sulphoacetic acid, para-toluenesulphonic acid (PTSA), sulphuric acid, methanesulphonic acid, their salts and combinations thereof. Preferably according to the invention, compound B is chosen among non-alkoxylated polyols, non-alkoxylated polyamines, non-alkoxylated amino alcohols, non-alkoxylated (polyamino)alcohols, non-alkoxylated amino(polyalcohols), non-alkoxylated oses, non-alkoxylated osides, alkoxylated polyols, alkoxylated polyamines, alkoxylated amino alcohols, alkoxylated (polyamino)alcohols, alkoxylated amino(polyalcohols), alkoxylated oses, alkoxylated osides and combinations thereof.

Also preferably according to the invention, compound B is chosen among non-alkoxylated polyols, non-alkoxylated oses, non-alkoxylated osides, alkoxylated polyols, alkoxylated oses, alkoxylated osides and combinations thereof, in particular alkoxylated polyols, non-alkoxylated polyols, non-alkoxylated oses, non-alkoxylated osides and combinations thereof.

Preferably according to the invention, compound B can comprise a number of alkoxylated groups ranging from 2 to 500, preferably from 10 to 250 or from 25 to 150. Preferably according to the invention, the alkoxylated groups are chosen among oxyethylene, oxypropylene, oxybutylene and combinations thereof. The preferred alkoxylated group is oxyethylene, optionally combined with oxypropylene.

More preferably according to the invention, compound B is chosen among glycerol, polyalkylene glycol (preferably polyalkylene glycol, polypropylene glycol, polybutylene glycol), pentaerythritol, triethanolamine, ethanolamine, diethanolamine, 3-amino-1-propanol, 1-amino-2-propanol, butanetriol, ethylene glycol, 1,3-propanediol, 1,4-butanediol, 1,6-hexanediol, pentaerythritol, sorbitol, 5-amino-1-pentanol, 2-(2-aminoethoxy)ethanol, N-(2-aminoethyl)ethanolamine, bis(N-hydroxyethyl)propane-1,3-diamine, diisopropanolamine, triisopropanolamine, N-methyldiethanolamine, N-butyldiethanolamine, ethylene glycol, diethylene glycol, triethylene glycol, 1,2-propanediol, 1,3-propanediol, 1,2,3-propanetriol, 1,2-butanediol, 1,4-butanediol, 2,3-butanediol, neopentyl glycol, trimethylolpropane, 1,2,4-butanetriol, 1,2-pentanediol, 1,5-pentanediol, 1,6-hexanediol, 2,5-dimethyl-2,5-hexanediol, D-arabinose, L-arabinose, D-xylose, D-glucose, D-mannose, D-galactose, D-glucosamine, D-fructose, maltose, sucrose, lactose, ethylenediamine, diethylenetriamine, triethylenetetramine, 1,3-diaminopropane, 1,2-diaminopropane, neopentyldiamine, hexamethylenediamine, octamethylenediamine, N-(2-aminoethyl)propane-1,3-diamine, 1,2,3-propanetriamine, N,N-bis(3-aminopropylamine) and combinations thereof, preferably chosen among glycerol, triethanolamine, trimethylolpropane, 1,2,4-butanetriol, ethylene glycol, 1,3-propanediol, 1,4-butanediol, 1,6-hexanediol, pentaerythritol, sorbitol and combinations thereof. Also preferably, compound B has a molecular mass ranging from 50 g/mol to 1,000 g/mol, preferably from 55 g/mol to 500 g/mol or from 55 g/mol to 250 g/mol.

Preferentially according to the invention, composition T comprises a molar amount of functional groups of compound B ranging from 5% to 100%, preferably from 10% to 100% or from 10% to 90% or from 20% to 100% or from 20% to 80%, relative to the total molar amount of carboxyl groups of polymer A.

Advantageously according to the invention, composition R comprises a molar amount of compound B ranging from 5% to 100%, preferably from 10% to 100% or from 10% to 90% or from 20% to 100% or from 20% to 80%, relative to the total molar amount of monomers.

Particularly advantageously, the invention avoids the use of certain chemical compounds or substances. Preferably according to the invention, composition T does not comprise any urea-formaldehyde compound or any formaldehyde compound. Advantageously, composition T does not comprise any compound comprising phosphorus in oxidation state I or any compound comprising phosphorus in oxidation state III or any compound comprising phosphorus in oxidation state V. Also advantageously, composition R does not comprise any urea-formaldehyde compound or any formaldehyde compound or does not comprise any compound comprising phosphorus in oxidation state I or any compound comprising phosphorus in oxidation state III or any compound comprising phosphorus in oxidation state V. Advantageously according to the invention, composition T does not comprise any elastomer.

Preferably according to the invention, composition T comprises a material E chosen among silicon, lithium, carbon graphite or graphitic carbon, hexagonal carbon, rhombohedral carbon and combinations thereof, optionally doped with at least one element, preferably chosen among lithium, germanium, silicon and combinations thereof. The preferred material E is chosen among carbon graphite, silicon and combinations thereof.

The invention also provides a method for preparing a composition T. The preparation method comprises:
the preparation of an aqueous composition R according to the invention,
the addition of at least one material E chosen among metal fibres, metal particles, carbon graphite fibres, carbon graphite particles and combinations thereof, preferably material E is chosen among silicon, lithium, carbon graphite or graphitic carbon, hexagonal carbon, rhombohedral carbon and combinations thereof, optionally doped with at least one element, preferably chosen among lithium, germanium, silicon and combinations thereof.

The invention also provides an aqueous composition R defined according to the invention as well as a method for preparing it. The method for preparing the aqueous composition R comprises preparing a polymer A according to the invention and then adding at least one polyfunctional compound B chosen among polyols, polyamines, amino alcohols, (polyamino)alcohols, amino(polyalcohols), oses, osides and combinations thereof.

The use of a sulphur compound C1 according to the invention when preparing polymer A leads to a method for preparing composition R comprising:
the preparation of a polymer A according to the invention,
optionally maintaining or adding at least one compound D chosen among a sulpho-carboxylic acid, a sulpho-carboxylic acid salt and combinations thereof to the aqueous dispersion of polymer A,
the addition of at least one polyfunctional compound B chosen among polyols, polyamines, amino alcohols, (polyamino)alcohols, amino(polyalcohols), oses, osides and combinations thereof.

The use of a phosphorus compound C2 or of a phosphorus compound C3 according to the invention when preparing polymer A leads to a method for preparing composition R comprising:
the preparation of a polymer A according to the invention in the presence of at least one compound C2 or of at least one compound C3,
optionally maintaining or adding at least one compound resulting from the reaction of monomer M with, respectively, compound C2 or at least one compound C3 to the aqueous dispersion of polymer A,
the addition of at least one polyfunctional compound B chosen among polyols, polyamines, amino alcohols, (polyamino)alcohols, amino(polyalcohols), oses, osides and combinations thereof.

The invention also provides an agent for crosslinking a polyfunctional compound B, a method for improving the cross-linking properties of an aqueous composition R using a compound D according to the invention, and the corresponding cross-linking improvement agent.

The cross-linking agent according to the invention for crosslinking an aqueous composition R comprises:
at least one α-sulphonated polymer A prepared in water, preferably in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV, and
at least one compound D chosen among a sulpho-carboxylic acid, a sulpho-carboxylic acid salt and combinations thereof.

The method for improving the cross-linking properties of an aqueous composition R comprises:
at least one aqueous dispersion of an α-sulphonated polymer A prepared in water, preferably in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound comprising sulphur in oxidation state IV,
at least one polyfunctional compound B chosen among polyols, polyamines, amino alcohols, (polyamino)alcohols, amino(polyalcohols), oses, osides and combinations thereof,
   comprises maintaining or adding at least one compound D chosen among a sulpho-carboxylic acid, a sulpho-carboxylic acid salt and combinations thereof to the aqueous dispersion of polymer A or to the aqueous composition R.

The agent for improving the cross-linking properties of an aqueous composition R comprises:
at least one α-sulphonated polymer A prepared in water, preferably in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound C1 comprising sulphur in oxidation state IV, and
at least one compound D chosen among a sulpho-carboxylic acid, a sulpho-carboxylic acid salt and combinations thereof

The aqueous anode composition T according to the invention can be used particularly effectively in the production of an anode. Thus, the invention provides a method for manufacturing an anode comprising:
the application of at least one composition T according to the invention onto a substrate,
the crosslinking of material E impregnated with composition R.

Preferably when manufacturing an anode according to the invention, at least one of the application or crosslinking steps is carried out at a pH of less than 7, preferably at a pH of less than 5. Preferably when manufacturing an anode according to the invention, crosslinking is carried out at a temperature ranging from 100 to 250° C., preferably from 150 to 240° C. or from 170 to 230° C.

The invention also provides an anode prepared according to the preparation method of the invention.

According to the invention, the particular, advantageous or preferred characteristics of composition T according to the invention define aqueous compositions R, preparation methods and corresponding agents as well as anodes according to the invention which are also particular, advantageous or preferred.

The following examples illustrate the various aspects of the invention.

### EXAMPLES

### Preparation and Characterisation of Polymer AA According to the Invention

In a 1-litre glass reactor equipped with a stirrer, a thermometer and a cooling system, a load of 6.66 g of sodium hypophosphite in 182 g of water is introduced at room temperature. Then, a solution of 0.01 g of iron sulphate heptahydrate in 0.74 g of water is added and 3 loads are prepared to be introduced in parallel for 2 hours. In a first beaker, 224.01 g of acrylic acid are introduced. In a second beaker, 23.12 g of hydrogen peroxide at 35% by mass in 19.9 g of water are introduced. In a third beaker, 6.03 g of sodium hypophosphite in 14 g of water are introduced. After an addition time of 2 hours at 97° C., a clear dispersion of polymer AA is obtained with a 45% concentration of dry solids, with a mass Mw of 3,855 g/mol and a PI of 2.0.

### Preparation and Characterisation of Polymer AB According to the Invention

In a 1 litre glass reactor equipped with a stirrer, a thermometer and a cooling system, a load comprising 0.006 g of iron sulphate heptahydrate and 380 g of water is prepared at room temperature. Then, 3 loads are prepared to be introduced in parallel for 3 hours. In a first beaker 623.5 g of acrylic acid are introduced, in a second beaker 5.086 g of sodium persulphate and 46.6 g of water are introduced, and in a third beaker 122.86 g of a 40% by mass aqueous sodium bisulphite solution are introduced. After an addition time of 3 hours at 73° C., a clear dispersion of polymer AB is obtained with a 55.2% concentration of dry solids, with a mass Mw of 4,430 g/mol and a PI of 2.2.

### Preparation and Characterisation of Polymer AC According to the Invention

In a 1 litre glass reactor equipped with a stirrer, a thermometer and a cooling system, a load comprising 0.023 g of iron sulphate heptahydrate and 284.13 g of water is prepared at room temperature. Then, 3 loads are prepared to be introduced in parallel for 3 hours. First, a load of 0.74 g of sodium persulphate and 19.68 g of water is introduced into the reactor, which has been heated to 80° C. Then, in a first beaker 450.99 g of acrylic acid are introduced, in a second beaker 1.96 g of sodium persulphate and 19.68 g of water are introduced, and in a third beaker 94.23 g of a 40% by mass aqueous sodium bisulphite solution are introduced. After 3 hours of addition at 80° C., a clear dispersion of polymer AC is obtained. This polymer is then neutralised by adding sodium hydroxide to a pH of 2.0. The concentration of dry solids is 50.0%. Polymer AC has a mass Mw of 6,000 g/mol and a PI of 2.7.

### Preparation of Compositions R According to the Invention

### Preparation of Composition RA1 According to the Invention

525.83 g of polymer dispersion AA, 2.30 g of sodium hypophosphite, 157.81 g of triethanolamine (polyfunctional compound B) and 321.60 g of water are mixed under stirring.

### Preparation of Composition RA2 According to the Invention

614.07 g of polymer dispersion AA, 3.50 g of sodium hypophosphite, 129.41 g of a 70% by mass aqueous sorbitol solution (polyfunctional compound B) and 309.34 g of water are mixed under stirring.

### Preparation of Composition RB1 According to the Invention

131.34 g of polymer dispersion AB, 22.7 g of glycerol (polyfunctional compound B) and 24.2 g of water are mixed under stirring.

### Preparation of Composition RC1 According to the Invention

146.46 g of polymer dispersion AC, 22.7 g of glycerol (polyfunctional compound B) and 24.2 g of water are mixed under stirring.

### Preparation and Characterisation of Anode Compositions T According to the Invention

### Preparation of Composition TA1 According to the Invention

A homogeneous mixture comprising 3.07 g of composition RA1, 83.16 g of deionised water and 80.75 g of carbon graphite (Xiamen Tob tb-sup-c65—CAS Number 1333-86-4) is prepared under stirring at 2,000 rpm (Hauschild Speed mixer DAC 400 FVZ). The resulting composition TA1 has a solids content of 60.6%.

### Preparation of Composition TA2 According to the Invention

A homogeneous mixture comprising 3.18 g of composition RA2, 51.42 g of deionised water and 80.35 g of carbon graphite (Xiamen Tob tb-sup-c65—CAS Number 1333-86-4) is prepared under stirring at 2,000 rpm (Hauschild Speed mixer DAC 400 FVZ). The resulting composition TA2 has a solids content of 60.5%.

### Preparation of Composition TB1 According to the Invention

A homogeneous mixture comprising 2.62 g of composition RB1, 49.02 g of deionised water and 70.39 g of carbon graphite (Xiamen Tob tb-sup-c65—CAS Number 1333-86-4) is prepared under stirring at 2,000 rpm (Hauschild Speed mixer DAC 400 FVZ). The resulting composition TB1 has a solids content of 58.8%.

### Preparation of Composition TC1 According to the Invention

A homogeneous mixture comprising 2.56 g of composition RC1, 49.02 g of deionised water and 70.22 g of carbon graphite (Xiamen Tob tb-sup-c65—CAS Number 1333-86-4) is prepared under stirring at 2,000 rpm (Hauschild Speed mixer DAC 400 FVZ). The resulting composition TC1 has a solids content of 58.7%.

A continuous, homogeneous layer of composition TA1 (thickness 250 μm—wet) is applied to a copper substrate (copper foil for anode, thickness 12 μm) using a Byko-Drive (BYK) automatic film applicator. It is left to dry at room temperature for 24 hours.

On a first sample at room temperature, the layer is wiped off manually. A partial transfer of the graphite onto the finger is visible, as is the deterioration of the layer of composition TA1 applied. In this sample, composition TA1 did not adhere sufficiently to the copper substrate to provide mechanical strength.

A second sample was placed in an oven at 205° C. for 10 minutes. After cooling to room temperature, the layer is wiped off manually. This does not cause the graphite to be transferred to the finger; the applied layer remained intact. In this second sample, the treated TA1 composition adhered correctly to the copper substrate to provide mechanical strength.

These assessments are reproduced using compositions TA2, TB1 and TC1. As with composition TA1, these compositions TA2, TB1 and TC1 adhere correctly to the copper substrate to provide mechanical strength.

1. An aqueous anode composition T, comprising:
a material E comprising metal fibers, metal particles, carbon graphite fibers, and/or carbon graphite particles; and
a cross-linkable aqueous composition R, comprising
(a) a polymer A prepared in water by a reaction comprising polymerizing a monomer comprising a monomer M comprising acrylic acid and/or methacrylic acid, optionally in salt form, in an environment comprising an initiator compound, and
(b) a compound B comprising a polyol, polyamine, amino alcohol, (polyamino)alcohols(polyamino), amino(polyalcohol), ose, and/or oside.

2. The composition T claim 1,
wherein the monomer M comprises the acrylic acid and/or an acrylic acid salt.

3. The composition T of claim 1, wherein the environment for preparing the polymer A further comprises a polymerization comprising:
C1 a sulfur compound comprising sulfur in oxidation state IV,
C2 a phosphorus compound comprising phosphorus in oxidation state I,
C3 a phosphorus compound comprising phosphorus in oxidation state III,
C4 a secondary alcohol C4,
C5 a sulfur compound, and/or
C6 a RAFT polymerization agent C6.

4. The composition T of claim 3, comprising, relative to total monomer moles
the sulfur compound C1 in a range of from 1 to 15 mol. %, or
the phosphorus compound C2 in a range of from 1 to 15 mol. %, or
the phosphorus compound C3 in a range of from 1 to 15 mol. %, or
the compound C6 in a range of from 1.5 to 12.5 mol. %.

5. The composition T of claim 1, wherein the polymer A
comprises an α-ω-disulphonated polymer A1, an α-monosulphonated polymer A2, a polymer A3 comprising phosphinate groups, a polymer A4 comprising phosphonate groups, and/or a polymer A5 comprising phosphinate groups and phosphonate groups, or
has a weight-average molecular mass Mw, measured of less than 1 million g/mol, or
has a weight-average molecular mass Mw, measured by SEC, of greater than 1,000 g/mol, or
polydispersity index PI, measured by SEC, of less than 4.

6. The composition T of claim 1, further comprising:
a compound D comprising a sulfo-carboxy-aromatic acid and/or sulfo-carboxy-alkyl acid; or
a compound F comprising 2-sulfoacetic acid, para-toluenesulfonic acid, sulfuric acid and/or methanesulfonic acid, optionally in salt form.

7. The composition T of claim 1, wherein the compound B:
comprises a non-alkoxylated polyol, non-alkoxylated polyamine, non-alkoxylated amino alcohol, non-alkoxylated (polyamino), non-alkoxylated amino(polyalcohol), non-alkoxylated ose, non-alkoxylated oside, alkoxylated polyol, alkoxylated polyamine, alkoxylated amino alcohol, alkoxylated (polyamino)amino), alkoxylated amino(polyalcohol), and/or an alkoxylated ose, alkoxylated oside; or
comprises glycerol, polyalkylene glycol pentaerythritol, triethanolamine, ethanolamine, diethanolamine, 3-amino-1-propanol, 1-amino-2-propanol, butanetriol, ethylene glycol, 1,3-propanediol, 1,4-butanediol, 1,6-hexanediol, pentaerythritol, sorbitol, 5-amino-1-pentanol, 2-(2-aminoethoxy)ethanol, N-(2-aminoethyl)ethanolamine, bis(N-hydroxyethyl)propane-1,3-diamine, diisopropanolamine, triisopropanolamine, N-methyldiethanolamine, N-butyldiethanolamine, ethylene glycol, diethylene glycol, triethylene glycol, 1,2-propanediol, 1,3-propanediol, 1,2,3-propanetriol, 1,2-butanediol, 1,4-butanediol, 2,3-butanediol, neopentyl glycol, trimethylolpropane, 1,2,4-butanetriol, 1,2-pentanediol, 1,5-pentanediol, 1,6-hexanediol, 2,5-dimethyl-2,5-hexanediol, D-arabinose, L-arabinose, D-xylose, D-glucose, D-mannose, D-galactose, D-glucosamine, D-fructose, maltose, sucrose, lactose, ethylenediamine, diethylenetriamine, triethylenetetramine, 1,3-diaminopropane, 1,2-diaminopropane, neopentyldiamine, hexamethylenediamine, octamethylenediamine, N-(2-aminoethyl)propane-1,3-diamine, 1,2,3-propanetriamine, N,N-bis(3-aminopropylamine) and combinations thereof, preferably chosen among glycerol, triethanolamine, trimethylolpropane, 1,2,4-butanetriol, ethylene glycol, 1,3-propanediol, 1,4-butanediol, 1,6-hexanediol, pentaerythritol, and/or sorbitol, or
has a molecular mass in a range of from 50 to 1,000 g/mol; or
has a molar amount of functional groups in a range of from 5 to 100 mol. %, relative to total carboxyl group moles the polymer A;
is present in a range of from 5 to 100 mol. %.

8. The composition T of claim 1, not comprising a urea-formaldehyde compound or a formaldehyde compound or a compound comprising phosphorus in oxidation state I or a compound comprising phosphorus in oxidation state III or a
compound comprising phosphorus in oxidation state V.

9. The composition T of claim 1, wherein the material E comprises silicon, lithium, carbon graphite, graphitic carbon, hexagonal carbon, and/or rhombohedral carbon, optionally further comprising an elemental dopant.

10. A method for preparing an aqueous composition T of claim 1, comprising:
preparing the aqueous composition R;
combining the aqueous composition R and the material E.

11. An aqueous composition R, comprising:
(a) a polymer A prepared in water by polymerizing a monomer comprising a monomer M comprising acrylic acid and/or methacrylic acid, optionally in salt form, in an environment comprising an initiator compound, and
(b) a compound B comprising a polyol, polyamine, amino alcohol, (polyamino)alcohols, amino(polyalcohol), ose, and/or oside.

12. A method for preparing the aqueous composition R of claim 11, comprising:
optionally adding a compound D comprising a sulfo-carboxylic acid and/or a sulfo-carboxylic acid salt to an aqueous dispersion of the polymer A; and
adding the compound B.

13. A cross-linking agent suitable for crosslinking an aqueous composition R of claim 11, the cross-linking agent comprising:
an α-sulfonated polymer A prepared in water by a reaction comprising polymerizing a monomer comprising a monomer M comprising acrylic acid, methacrylic acid, an acrylic acid salt, and/or a methacrylic acid salt, in an environment comprising an initiator and a sulfur compound comprising sulfur in oxidation state IV; and
a compound D comprising a sulfo-carboxylic acid and/or a sulfo-carboxylic acid salt.

14. A method for improving the cross-linking properties of the aqueous composition R of claim 11, the method comprising:
preparing an aqueous dispersion comprising (a) an α-sulphonated polymer A prepared in water by a reaction comprising polymerizing a monomer comprising a monomer M comprising acrylic acid, methacrylic acid, an acrylic acid salt, and/or a methacrylic acid salt, in an environment comprising an initiator and a sulfur compound comprising sulfur in oxidation state IV, and (b)
a polyfunctional compound B comprising a polyol, polyamine, amino alcohol, (polyamino)alcohol, amino(polyalcohol), ose, and/or an oside; and
maintaining or adding a compound D comprising a sulfo-carboxylic acid and/or a sulfo-carboxylic to the aqueous dispersion of polymer A or to the aqueous composition R.

15. An agent configured for improving cross-linking properties of an aqueous composition R of claim 11, the agent comprising:
an α-sulphonated polymer A prepared in water by a reaction comprising polymerizing a monomer comprising a monomer M comprising acrylic acid, methacrylic acid, an acrylic acid salt, and/or a methacrylic acid salt, in an environment comprising an initiator and a sulfur compound C1 comprising sulfur in oxidation state I V; and
a compound D comprising a sulfo-carboxylic acid and/or a sulfo-carboxylic acid salt.

16. A method for producing an anode, the method comprising:
applying the composition T of claim 1 onto a substrate,
crosslinking an impregnated material E using a composition R comprising.

17. An anode, prepared by the method of claim 16.

18. The composition T of claim 1, wherein the monomer further comprises a second monomer comprising vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulfonic acid, maleic acid, maleic anhydride, and/or itaconic acid.

19. The composition T of claim 1, wherein the monomer M comprises the acrylic acid and/or an acrylic acid salt, and
wherein the monomer further comprises a second monomer comprising vinyl acetate, ethyl acrylate, methyl acrylate, hydroxyethylmethacrylate, hydroxyethylacrylate, hydroxypropylmethacrylate, hydroxypropylacrylate, 2-acrylamido-2-methylpropane sulfonic acid, maleic acid, maleic anhydride, and/or itaconic acid.

20. The composition T of claim 1, wherein the polymer A is at least partially neutralized.
